(19) United States
(12) Patent Application Publication
(10) Pub. No.: US 2025/0378806 A1
(43) Pub. Date: Dec. 11, 2025

(54) METHOD, DEVICE, AND STORAGE MEDIA FOR MUSIC GENERATION

(71) Applicants: Lemon Inc., Grand Cayman (KY); Beijing Zitiao Network Technology Co., Ltd., Haidian District, Beijing (CN)

(72) Inventors: Dong Guo, CULVER CITY, CA (US); Peng Zhang, Los Angeles, CA (US); Xinyan He, Beijing (CN); Bin Chen, Los Angeles, CA (US)

(21) Appl. No.: 18/740,208

(22) Filed: Jun. 11, 2024

(51) Int. Cl. G10H 1/00; G06V 20/40

(52) U.S. Cl. CPC G10H 1/0025; G06V 20/41

(57) ABSTRACT

Embodiments of the present disclosure provide a solution for music generation. A method comprises: determining a set of music materials from a music material library based on semantic information of a video content; determining motion information of a video content based on a difference between a set of frames of the video content; and obtaining a music content generated based on the set of music materials and the motion information, wherein a structure of the music content matches with the motion information of the video content.

### FIELD

The disclosed example embodiments relate generally to the field of computer science, particularly to a method, device, and storage medium for music generation.

### BACKGROUND

In the domain of music generation, traditional approaches have typically involved manual composition by skilled musicians or the use of pre-recorded music tracks that may not perfectly align with the emotional and thematic content of a video. The advent of technology has introduced automated music generation systems, yet these often fall short in creating music that is contextually relevant and dynamically synchronized with visual media.

### SUMMARY

In a first aspect of the present disclosure, there is provided a method for music generation. The method comprises: determining a set of music materials from a music material library based on semantic information of a video content; determining motion information of a video content based on a difference between a set of frames of the video content; and obtaining a music content generated based on the set of music materials and the motion information, wherein a structure of the music content matches with the motion information of the video content.

In a second aspect of the present disclosure, there is provided an electronic device. The device comprises at least one processing unit; and at least one memory coupled to the at least one processing unit and storing instructions executable by the at least one processing unit, the instructions, upon execution by the at least one processing unit, causing the device to perform the steps of the method of the first aspect.

In a third aspect of the present disclosure, there is provided an apparatus. The apparatus comprises: a first determining module, configured to determine a set of music materials from a music material library based on semantic information of a video content; a second determining module, configured to determine motion information of a video content based on a difference between a set of frames of the video content; and a music obtaining module, configured to obtain a music content generated based on the set of music materials and the motion information, wherein a structure of the music content matches with the motion information of the video content.

In a fourth aspect of the present disclosure, a non-transitory computer-readable storage medium is provided. The non-transitory computer-readable storage medium has a computer program stored thereon which, upon execution by an electronic device, causes the device to perform actions comprising: in response to an effect behavior editing request, presenting an effect behavior panel for an effect in an edit mode; providing at least one command edit region in the effect behavior panel, a command edit region comprising an object select box to select at least one object in the effect, an action select box to select an action to be performed by the at least one object, and a trigger select box to select a trigger for triggering the action; and applying a target action command for a target object into the effect based on receiving, within a command edit region, a selection of a target object, a selection of a target action to be performed by the target object, and a selection of a target trigger for triggering the target action, the target action command defining that the target object performs the target action when the target trigger occurs.

It would be appreciated that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a flow chart of a process for music generation in accordance with some embodiments of the present disclosure;

FIGS. 3A-3C illustrate example processes for music generation in accordance with some embodiments of the present disclosure;

FIG. 4 illustrates a block diagram of an apparatus for music generation in accordance with some embodiments of the present disclosure; and

FIG. 5 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

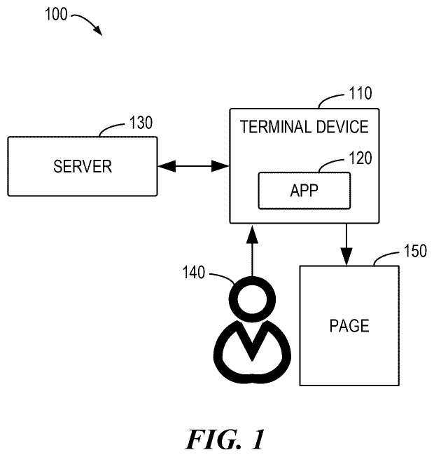

FIG. 1 illustrates a schematic diagram of an example environment 100 in which embodiments of the present disclosure can be implemented. In the example environment 100 of FIG. 1, an application 120 is installed in the terminal device 110. A user 140 may interact with the application 120 via the terminal device 110 and/or an attached device of the terminal device 110.

In some embodiments, the application 120 may be a content sharing application (e.g., a video application that focuses on video sharing), which is capable of providing various types of services to user 140, such as music generation service.

In the example environment 100 of FIG. 1, if the application 120 is active, the terminal device 110 may present a page 150 of the application 120. The page 150 may include various types of pages that the application 120 can provide.

In some embodiments, the terminal device 110 communicates with a server 130 to enable provisioning of services to the application 120. The terminal device 110 may be any type of mobile terminal, fixed terminal, or portable terminal, including a mobile phone, a desktop computer, a laptop, a notebook, a netbook, a tablet, a media computer, a multimedia tablet, a personal communication system (PCS) device, a personal navigation device, a personal digital assistant (PDA), an audio/video player, a digital camera/video camera, positioning device, television receiver, radio broadcast receiver, e-book device, gaming device, or any combination of the foregoing, including accessories and peripherals for these devices or any combination thereof. In some embodiments, the terminal device 110 can also support any type of user-specific interface (such as “wearable” circuitry). The server 130 can be various types of computing systems/servers capable of providing computing capability, including but not limited to, a mainframe, an edge computing node, a computing device in cloud environment, and the like.

It should be understood that the structure and function of each element in the environment 100 is described for illustrative purposes only and does not imply any limitations on the scope of the present disclosure.

As discussed, traditional technology has introduced automated music generation systems, yet these often fall short in creating music that is contextually relevant and dynamically synchronized with visual media. The challenge lies in the complexity of interpreting video content—comprehending its semantic meaning and motion dynamics—to produce music that complements these aspects in real-time. Previous attempts at automated solutions have been hindered by limitations in computational efficiency, the accuracy of semantic understanding, and the synchronization of music structure with video motion, resulting in a need for a more sophisticated and responsive system.

According to embodiments of the present disclosure, an improved solution for music generation is proposed. According to the solution of embodiments of the present disclosure, a set of music materials may be determined from a music material library based on semantic information of a video content. Further, motion information of the video content may be determined based on a difference between a set of frames of the video content. Accordingly, a music content generated may be obtained based on the set of music materials and the motion information, wherein a structure of the music content matches with the motion information of the video content.

In this way, the embodiments of the present disclosure may generate music that is semantically aligned with video content, ensuring thematic relevance. Further, by synchronizing the music structure with the video's motion information, the embodiments of the present disclosure may enhance the audio-visual experience, creating a more immersive and emotionally resonant synchronization.

Some example embodiments of the present disclosure will continue to be described below with reference to the accompanying drawings.

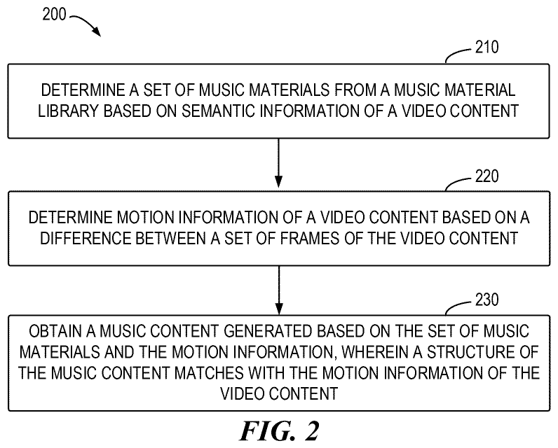

FIG. 2 illustrates a flow chart of a process 200 for music generation in accordance with some embodiments of the present disclosure. The process 200 can be implemented at an electronic device which operates for music generation, for example, the terminal device 110 and/or the server 130 as shown in FIG. 1.

As shown in FIG. 2, at block 210, the electronic device determines a set of music materials from a music material library based on semantic information of a video content.

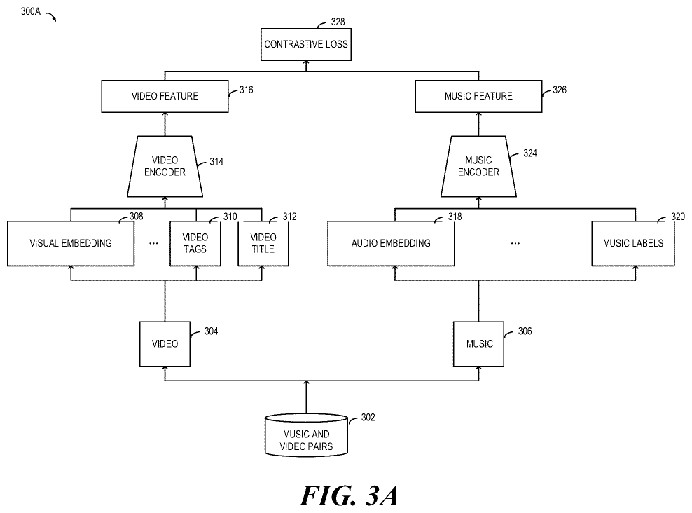

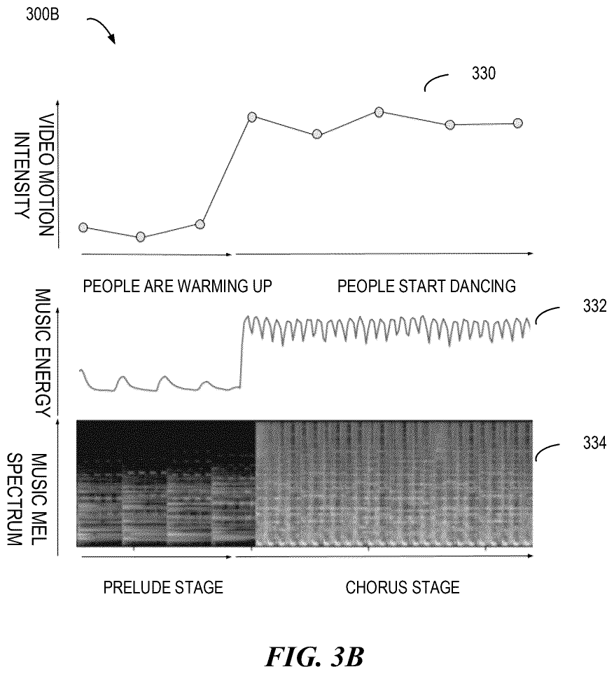

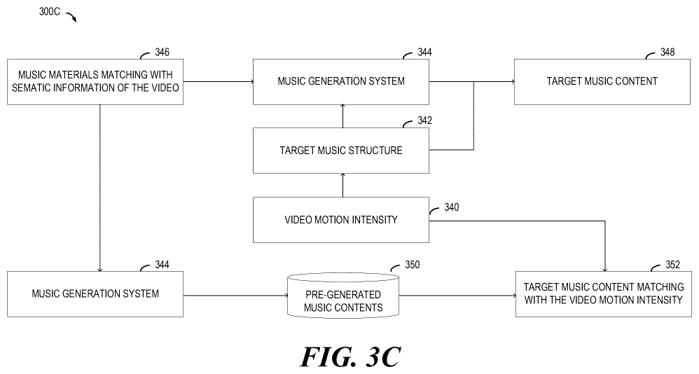

In some embodiments, the electronic device may utilize a Deep Structured Semantic Model DSSM 300A as shown in FIG. 3A to determine a set of music materials from a music material library.

As shown in FIG. 3A, the DSSM 300A may comprise a video encoder 314 and a music encoder 324. The DSSM 300A may be trained using a plurality of music and video pairs 302. Each pair may comprise a video sample 304 and a corresponding music sample 306.

The video encoder 314 may generate the training video feature 316 of the video sample 304. For example, the video encoder 314 may obtain the visual embedding 308 and/or textual description information of the video sample 304.

In some embodiments, the visual embedding 308 may be generated using any proper video understanding model. Additionally, the textual description information may comprise video tags 310, a video title 312 and any other proper description text.

Similarly, the music encoder 312 may generate the training music feature 326 of the video sample 306. For example, the video encoder 314 may obtain the audio embedding 318 and/or textual description information of the music sample 306. For example, the textual description information of the music sample 306 may comprise any proper types of music labels 320, e.g., a music style label.

Further, a contrastive loss 328 may be determined based on the training video feature 316 and the corresponding training music feature 326. The video encoder 314 and the music encoder 324 in the DSSM 300A may be jointly trained based on the contrastive loss 328.

In this way, a unified music-video vector space may be constructed, and the video contents and music contents may be converted to the same vector space for searching.

After the training of the video encoder 314 and the music encoder 324, the electronic device may determine a first semantic feature of the video content to be processed using the trained video encoder 314.

Further, a set of second semantic features may be generated based on the music material library using the trained music encoder 324. Accordingly, the electronic device may determine the set of music materials from the music material library based on a comparison between the first semantic feature and the second semantic features.

Referring back to FIG. 2, at block 220, the electronic device determines motion information of a video content based on a difference between a set of frames of the video content.

In some embodiments, the motion intensity of a video content may be determined by analyzing the differences between consecutive frames or a set of frames within the video content.

For example, the pixel changes between these frames may be quantified, which serves as an indicator of the motion's vigor. Essentially, greater pixel variation suggests more intense motion, while minimal changes imply a slower pace or static scene. By capturing these variations over time, the system can effectively gauge the video's motion intensity, allowing for a dynamic and responsive generation of music that corresponds to the visual rhythm of the video.

In some embodiments, the motion information may comprise a motion intensity of the video content, which may be determined based on the pixel differences between consecutive frames or a set of frames within the video content.

A video with high motion intensity is characterized by abrupt and lively changes, often reflecting swift actions or pivotal plot twists, which captivate the viewer's attention. On the other hand, a video with subdued and gradual visual shifts exudes low motion intensity, typically evoking a sense of calm and tranquility. The conveyance of video motion intensity is achieved through the extent of frame-to-frame alterations, the velocity of motion, and the pacing of scene transitions, all of which shape our perceptual and emotional engagement with the content.

At block 230, the electronic device obtains a music content generated based on the set of music materials and the motion information, wherein a structure of the music content matches with the motion information of the video content.

FIG. 3B depicts a schematic representation 300B illustrating the synchronization requirement for the structural alignment of energy fluctuations between a video content and its accompanying music over a timeline.

In an exemplified scenario of a “dance” video, as shown in the diagram 330, the initial phase is characterized by a low motion intensity state, such as warm-up, which is followed by a marked escalation to a high motion intensity state as the dancers commence their movements. This transition is represented by a transition from low to high motion intensity, observable in the video's motion intensity profile indicated by data points plotted over time.

The diagram 332 and diagram 334 of FIG. 3B delineate the corresponding temporal evolution of the music's energy, presented in terms of quantified musical energy and its Mel frequency cepstral coefficients (Mel spectrogram), respectively. An energy of the music may indicate the variance intensity of the music content.

The music's dynamic rise in energy is designed to coincide with the abrupt augmentation of the video's motion intensity, as exemplified by the Mel spectrogram's progression from the preludial segment to the chorus at the video's kinetic peak.

For the selection of the target music's intensity, a comparative analysis is conducted to determine the degree of similarity between the temporal patterns of energy variation in the music (as shown in the diagram 332 of FIG. 3B) and the motion intensity of the video (as depicted at the diagram 330 of FIG. 3B). The energy variations of both the music and video are encapsulated in numerical arrays, enabling the application of a correlation coefficient to quantify the congruence between the music's energy trajectory and the video's motion intensity profile. Additionally, the magnitude of the music's energy change at the instant of the video's most significant motion intensity shift is calculated. These metrics are integrated to formulate a correlation level that evaluates the structural compatibility and synchronization precision of the music relative to the video's dynamic progression.

FIG. 3C illustrates an example process 300C for determining the target music content based on the music materials and the video motion intensity.

As shown in FIG. 3C, the electronic device may generate a target music structure 342 based on the motion information of the video content, such as, video motion intensity 340.

Further, the set of music materials 346 matching with the semantic information of the video content and the target music structure 342 may be provided to the music generation system 344, and the target music content 348 may be generated by the music generation system.

In this way, the correlation level between the variance intensity of the generated target music content 348 and a motion intensity 340 indicated by the motion information may be greater than a threshold.

In some further embodiments, the target music content 352 may also be determined from a set of pre-generated music contents 350 based on the video motion intensity 340.

For example, the music generation system 344 may generate a set of candidate music contents (e.g., the pre-generated music contents 350) based on a set of predetermined music structures.

Further, the electronic device may determine a target music content 352 from the set of candidate music content 350. The structure of the target music content 352 shall match with the motion information of the video content. For example, the correlation level between the variance intensity of the generated target music content 352 and a motion intensity 340 indicated by the motion information may be greater than a threshold.

In some embodiments, the target music content (e.g., the target music content 348 or the target music content 352) may be added to the video content as a background music.

In this way, the embodiments of the present disclosure may generate music that is semantically aligned with video content, ensuring thematic relevance. Further, by synchronizing the music structure with the video's motion information, the embodiments of the present disclosure may enhance the audio-visual experience, creating a more immersive and emotionally resonant synchronization.

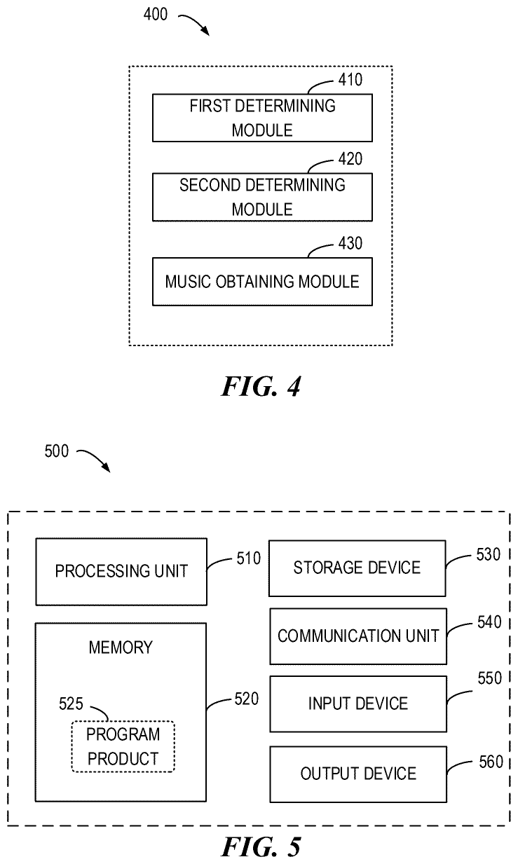

FIG. 4 shows a block diagram of an apparatus 400 for music generation in accordance with some embodiments of the present disclosure. The apparatus 400 may be implemented, for example, or included at the terminal device 110 of FIG. 1. Various modules/components in the apparatus 400 may be implemented by hardware, software, firmware, or any combination thereof.

As shown, the apparatus 400 includes a first determining module 410, configured to determine a set of music materials from a music material library based on semantic information of a video content; a second determining module 420, configured to determine motion information of a video content based on a difference between a set of frames of the video content; and a music obtaining module 430, configured to obtain a music content generated based on the set of music materials and the motion information, wherein a structure of the music content matches with the motion information of the video content.

In some embodiments, the first determining module 410 is further configure for: determining a first semantic feature of the video content using a video encoder; and determining the set of music materials from the music material library based on a comparison between the first semantic feature and a second semantic feature of a music material in the music material library.

In some embodiments, the second semantic feature is generated using a music encoder, and the video encoder and the music encoder are jointly trained through the following process: obtaining a plurality of training pairs, each training pair comprising a video sample and a corresponding music sample; generating a training video feature of the video sample and a training music feature of the corresponding music sample; determining a contrastive loss based on the training video feature and the training music feature; and jointly training the video encoder and the music encoder based on the contrastive loss.

In some embodiments, the first sematic feature is generated based on at least one of: visual embedding of the video content, or textual description information of the video content; and/or wherein the second sematic feature is generated based on at least one of: audio embedding of the music content, or textual description information of the music content.

In some embodiments, the structure of the music content indicates a distribution of energy of the music content, the energy indicating a variance intensity of the music content.

In some embodiments, a correlation level between the variance intensity of the music content and a motion intensity indicated by the motion information is greater than a threshold.

In some embodiments, the music obtaining module 430 is further configure for: generating a target music structure based on the motion information of the video content; and generating, according to the target music structure, the music content based on the set of candidate music materials.

In some embodiments, the music obtaining module 430 is further configure for: obtaining a set of candidate music contents generated based on a set of predetermined music structures; and determining a target music content from the set of candidate music contents, wherein a structure of the target music content matches with the motion information of the video content.

In some embodiments, the apparatus 400 further comprises an adding module configure to add the music content to the video content as a background music.

FIG. 5 illustrates a block diagram of an electronic device 500 in which one or more embodiments of the present disclosure can be implemented. It would be appreciated that the electronic device 500 shown in FIG. 5 is only an example and should not constitute any restriction on the function and scope of the embodiments described herein. The electronic device 500 may be used, for example, to implement the terminal device 110 of FIG. 1. The electronic device 500 may also be used to implement the apparatus 400 of FIG. 4.

As shown in FIG. 5, the electronic device 500 is in the form of a general computing device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and can execute various processes according to the programs stored in the memory 520. In a multiprocessor system, multiple processing units execute computer executable instructions in parallel to improve the parallel processing capability of the electronic device 500.

The electronic device 500 typically includes a variety of computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 530 may be any removable or non-removable medium, and may include a machine-readable medium, such as a flash drive, a disk, or any other medium, which can be used to store information and/or data (such as training data for training) and can be accessed within the electronic device 500.

The electronic device 500 may further include additional removable/non-removable, volatile/non-volatile storage medium. Although not shown in FIG. 5, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 may include a computer program product 525, which has one or more program modules configured to perform various methods or acts of various embodiments of the present disclosure.

The communication unit 540 communicates with a further computing device through the communication medium. In addition, functions of components in the electronic device 500 may be implemented by a single computing cluster or multiple computing machines, which can communicate through a communication connection. Therefore, the electronic device 500 may be operated in a networking environment using a logical connection with one or more other servers, a network personal computer (PC), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) through the communication unit 540 as required. The external device, such as a storage device, a display device, etc., communicate with one or more devices that enable users to interact with the electronic device 500, or communicate with any device (for example, a network card, a modem, etc.) that makes the electronic device 500 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method for music generation, comprising:
determining a set of music materials from a music material library based on semantic information of a video content;
determining motion information of a video content based on a difference between a set of frames of the video content; and
obtaining a music content generated based on the set of music materials and the motion information, wherein a structure of the music content matches with the motion information of the video content.

2. The method of claim 1, wherein determining a set of music materials from a music material library based on semantic information of a video content comprises:
determining a first semantic feature of the video content using a video encoder; and
determining the set of music materials from the music material library based on a comparison between the first semantic feature and a second semantic feature of a music material in the music material library.

3. The method of claim 2, wherein the second semantic feature is generated using a music encoder, and the video encoder and the music encoder are jointly trained through the following process:
obtaining a plurality of training pairs, each training pair comprising a video sample and a corresponding music sample;
generating a training video feature of the video sample and a training music feature of the corresponding music sample;
determining a contrastive loss based on the training video feature and the training music feature; and
jointly training the video encoder and the music encoder based on the contrastive loss.

4. The method of claim 2, wherein the first sematic feature is generated based on at least one of: visual embedding of the video content, or textual description information of the video content; and/or
wherein the second sematic feature is generated based on at least one of: audio embedding of the music content, or textual description information of the music content.

5. The method of claim 1, wherein the structure of the music content indicates a distribution of energy of the music content, the energy indicating a variance intensity of the music content.

6. The method of claim 1, wherein a correlation level between the variance intensity of the music content and a motion intensity indicated by the motion information is greater than a threshold.

7. The method of claim 1, wherein obtaining a music content generated based on the set of music materials and the motion information comprises:
generating a target music structure based on the motion information of the video content; and
generating, according to the target music structure, the music content based on the set of candidate music materials.

8. The method of claim 1, wherein obtaining a music content generated based on the set of music materials and the motion information comprises:
obtaining a set of candidate music contents generated based on a set of predetermined music structures; and
determining a target music content from the set of candidate music contents, wherein a structure of the target music content matches with the motion information of the video content.

9. The method of claim 1, further comprising:
adding the music content to the video content as a background music.

10. An electronic device, comprising:
at least one processing unit; and
at least one memory coupled to the at least one processing unit and storing instructions executable by the at least one processing unit, the instructions, upon execution by the at least one processing unit, causing the electronic device to perform actions comprising:
determining a set of music materials from a music material library based on semantic information of a video content;
determining motion information of a video content based on a difference between a set of frames of the video content; and
obtaining a music content generated based on the set of music materials and the motion information, wherein a structure of the music content matches with the motion information of the video content.

11. The electronic device of claim 10, wherein determining a set of music materials from a music material library based on semantic information of a video content comprises:
determining a first semantic feature of the video content using a video encoder; and
determining the set of music materials from the music material library based on a comparison between the first semantic feature and a second semantic feature of a music material in the music material library.

12. The electronic device of claim 11, wherein the second semantic feature is generated using a music encoder, and the video encoder and the music encoder are jointly trained through the following process:
obtaining a plurality of training pairs, each training pair comprising a video sample and a corresponding music sample;
generating a training video feature of the video sample and a training music feature of the corresponding music sample;
determining a contrastive loss based on the training video feature and the training music feature; and
jointly training the video encoder and the music encoder based on the contrastive loss.

13. The electronic device of claim 11, wherein the first sematic feature is generated based on at least one of: visual embedding of the video content, or textual description information of the video content; and/or
wherein the second sematic feature is generated based on at least one of: audio embedding of the music content, or textual description information of the music content.

14. The electronic device of claim 10, wherein the structure of the music content indicates a distribution of energy of the music content, the energy indicating a variance intensity of the music content.

15. The electronic device of claim 10, wherein a correlation level between the variance intensity of the music content and a motion intensity indicated by the motion information is greater than a threshold.

16. The electronic device of claim 10, wherein obtaining a music content generated based on the set of music materials and the motion information comprises:
generating a target music structure based on the motion information of the video content; and
generating, according to the target music structure, the music content based on the set of candidate music materials.

17. The electronic device of claim 1, wherein obtaining a music content generated based on the set of music materials and the motion information comprises:
obtaining a set of candidate music contents generated based on a set of predetermined music structures; and
determining a target music content from the set of candidate music contents, wherein a structure of the target music content matches with the motion information of the video content.

18. The electronic device of claim 10, the actions further comprising:
adding the music content to the video content as a background music.

19. A non-transitory computer-readable storage medium, having a computer program stored thereon which, upon execution by an electronic device, causes the device to perform actions comprising:
determining a set of music materials from a music material library based on semantic information of a video content;
determining motion information of a video content based on a difference between a set of frames of the video content; and
obtaining a music content generated based on the set of music materials and the motion information, wherein a structure of the music content matches with the motion information of the video content.
